(19) United States
(12) Patent Application Publication
(10) Pub. No.: US 2009/0039818 A1
(43) Pub. Date: Feb. 12, 2009

(54) DRIVE SYSTEM

(75) Inventor: Dieter Eckardt, Herzogenaurach (DE)

Correspondence Address: Henry M. Feiereisen;Henry M. Feiereisen, LLC, Suite 1501, 708 Third Avenue, New York, NY, 10017, US

(73) Assignee: Siemens Aktiengesellschaft, Munchen (DE)

(21) Appl. No.: 12/172,531

(22) Filed: Jul. 14, 2008

(30) Foreign Application Priority Data
Aug. 10, 2007 (DE) 10 2007 037 850.7

(51) Int. Cl. H02P 31/00

(52) U.S. Cl. 318/558

(57) ABSTRACT

A drive system for a shaft of a machine is described, which includes a control device, a drive controller and at least one input receiving input signals and at least one output supplying output signals. The drive controller includes drive controller firmware which stores linkable functional control elements. The control device enables both logical combination of individual inputs and/or outputs and/or internal states and parameterization and/or configuration of the functional control elements. The drive controller and the control device in the drive system are synchronized, with the drive controller operating as master. A drive system therefore has Programmed Logic Controller (PLC) functionality.

### CROSS-REFERENCES TO RELATED APPLICATIONS

This application claims the priority of German Patent Application, Serial No. 10 2007 037 850.7, filed 10 Aug. 2007, pursuant to 35 U.S.C. 119(a)-(d), the content of which is incorporated herein by reference in its entirety as if fully set forth herein.

### BACKGROUND OF THE INVENTION

The present invention relates to a drive system for a shaft of a machine.

Nothing in the following discussion of the state of the art is to be construed as an admission of prior art.

Such drive systems, in particular drive systems which comprise a drive controller, are generally known. Furthermore, it is also known that such drive systems comprise at least one respective input for receiving input signals and one respective output for outputting output signals. To a limited extent, the drive controller makes enables a combination of such input signals and/or internal states for the purpose of generating output signals which can be output via a respective output.

In frequency converters (converters for short), as an example of a drive system, in particular those for so-called standard drives, the firmware is compiled in full and is stored in the converter in the form of an unalterable software block for historical and economic reasons. Parameters are implemented in order to nevertheless be able to scale the functionality (for example activate/deactivate functions, set ramp time, etc.). Limited variation of the structure is also possible with the applicant's drives, in particular those which support so-called BiCo technology. Connectors have been introduced for this purpose, which connectors are basically parameters again but in which the address of a signal source, which is intended to be used to establish a “connection”, can be entered. In this case, all parameters can, in principle, be used as the signal source. Furthermore, one or more parameters are nowadays used to assign attributes to the digital and analog input signals, which attributes allocate a specific meaning to the input, for example on/off, clockwise running/anticlockwise running, etc. Moreover, so-called free functional modules which provide a limited number of functions, such as AND/OR, COUNTER, TIMER, ADDER, etc., and can be integrated into the runtime structure of the drive using BiCo technology have also been implemented. So-called macro parameters which in turn influence a number of other parameters according to certain rules round off the contemporary picture. However, the increasing flexibility and scalability is associated with the fact that it is more difficult to gain an overview of the multiplicity of parameters. In this context, functionalities, such as the parameters which can be assigned to the digital inputs or the macro parameters, tend rather to increase the complexity. In addition, the limited number of free modules limits the use of the drive, which is actually designed as a standard drive, for many applications.

It would therefore be desirable and advantageous to address prior art shortcomings.

### SUMMARY OF THE INVENTION

According to one aspect of the present invention, a drive system for a shaft, in particular a drive system for not more than one shaft, includes a control device with at least one input for receiving input signals and one output for outputting output signals, and a drive controller with drive controller firmware that stores combinable functional control elements, wherein the drive controller and the control device are synchronized inside the drive system and the drive controller operates as a master. The control device allows both logical combination of the at least one input or the at least one output or internal states and at least one of parameterization and configuration of the functional control elements. By operating as a master, the drive controller may set, for example, the clock rate for both the drive controller and the control device.

The present invention resolves prior art problems by eliminating with the integrated control device process outputs, i.e., interfaces to devices located outside the drive system.

According to one embodiment of the invention, both the control device and the drive controller each have their own dedicated processor which activates a control device functionality and/or drive controller firmware stored in a memory associated with the control device and the drive controller. In addition, the control device can also be implemented separate from the drive controller inside the drive system, thereby eliminating or at least minimizing the risk that the control device and the drive controller influence each other. In the context of the invention, hardware, software or firmware elements which are used to implement various functions in the control device and/or the drive controller are referred to hereinafter as “control device functionality” and “drive controller firmware”, regardless how these elements and functions are implemented, i.e., in software, hardware or firmware.

According to another embodiment of the invention, the drive system can be simplified and its costs reduced by providing a common processor for the control device and the drive controller. This common processor activates a control device functionality and/or drive controller firmware stored in the memory associated with the control device.

According to another embodiment of the invention, the control device and the drive controller each comprise drive controller firmware stored in a memory associated with the control device and a memory associated with the drive controller.

According to yet another embodiment of the invention, a coupling element may be provided which operatively connects the drive controller and the control device for synchronizing the drive controller with the control device. The drive controller and the connected control device are synchronized either by the drive controller or by the control device. The coupling element may be a dual-port Random-Access-Memory (RAM).

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a simplified schematic diagram of a drive system according to the invention, and

FIG. 2 shows further details of a drive controller and a control device that are part of the drive system according to the invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

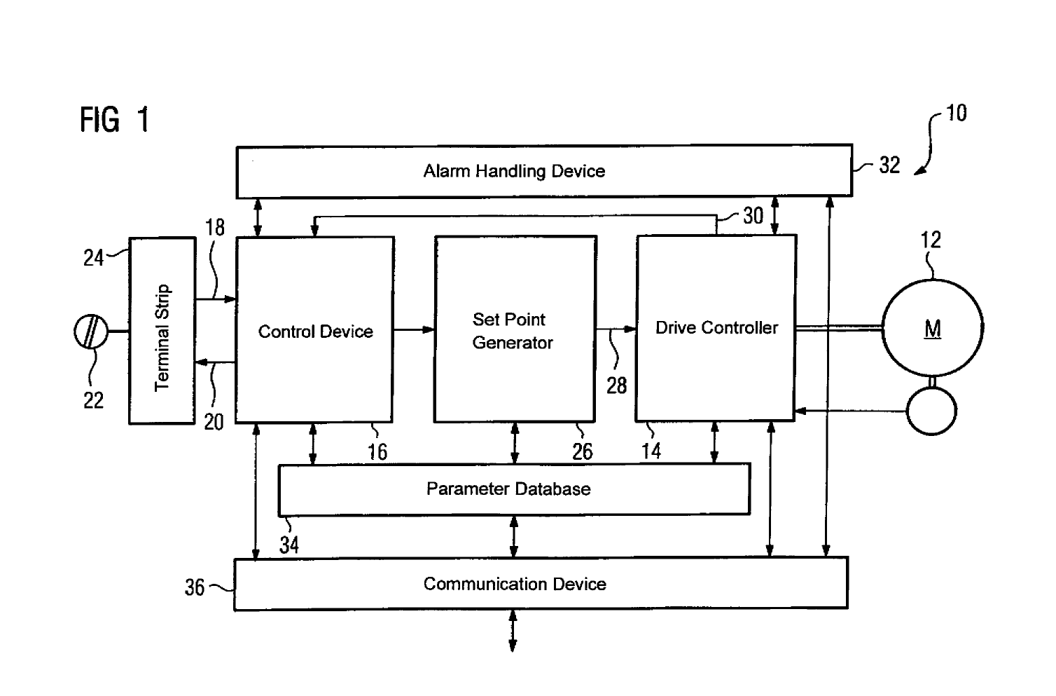

Turning now to the drawing, and in particular to FIG. 1, there is shown a drive system, generally designated by reference numeral 10, for a shaft (not separately illustrated) which is driven by a motor 12. The drive system 10 includes a drive controller 14, a control device 16 and at least one input 18 for receiving input signals and at least one output 20 for supplying output signals. The inputs and outputs 18, 20 are connected to external process peripherals 22 by a terminal strip 24.

The drive system 10 also includes a set point generator 26 which is functionally arranged between the control device 16 and the drive controller 14. A set point 28 supplied by the set point generator 26 can be influenced by the control device 16. The drive controller 14 and the control device 16 are connected via a feedback loop 30, so that the control device 16 also be influenced by the drive controller 14. The drive controller 14 and the control device 16 also use a joint alarm handling device 32. Furthermore, the drive controller 14, the control device 16 and the set point generator 26 use a common parameter database 34, and all of the aforementioned units, i.e., the drive controller 14, the control device 16, the set point generator 26, and the parameter database 34 are operatively connected to a communication device 36, for example a bus provided in the drive system 10, allowing communication with other devices, for example additional drive systems 10 or a superordinate unit (not illustrated).

The drive system 10 according to the invention thus includes as a flexible part the control device 16, and a real-time drive control system formed of the combination of the set point generator 26 and the drive controller 14. The real-time drive control system may be implemented as a combined firmware block.

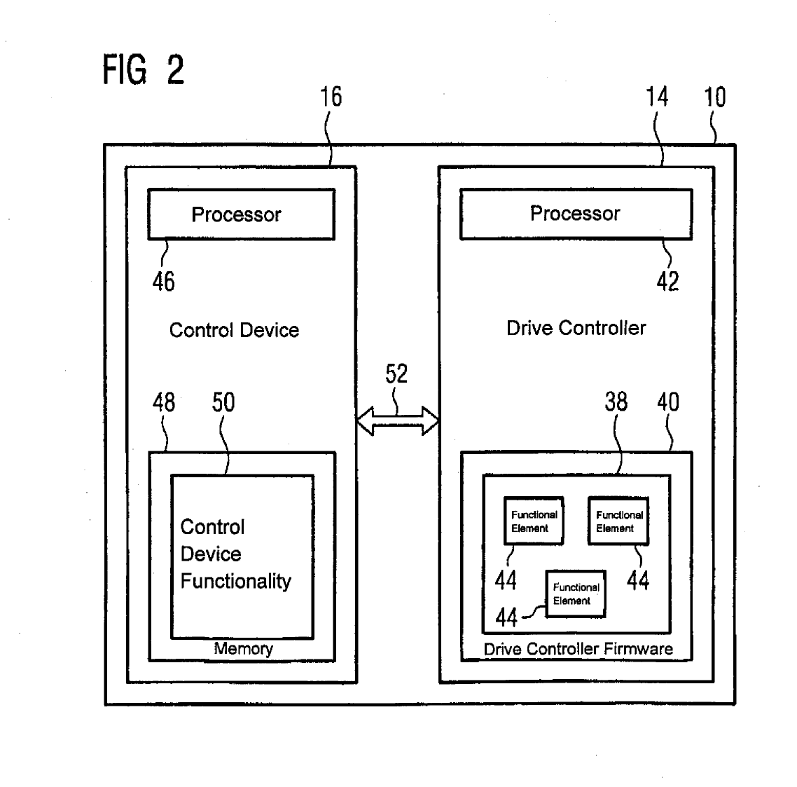

FIG. 2 shows the drive controller 14 and the control device 16 of the drive system 10 in more detail. As seen in FIG. 2, the drive controller 14 includes drive controller firmware 38 stored in a memory 40 which is associated with the drive controller 14 or can be accessed by the drive controller 14. The drive controller firmware 38 is activated by a processor 42, which is part of the drive controller 14, or a comparable processing functionality. The drive controller firmware 38 includes linkable functional control elements 44 which can be linked to, for example, structural control elements, such as delay elements and the like (not illustrated).

The control device 16 also includes a processor 46 or a comparable processing functionality and, in a memory 48 which is associated with the control device 16 or can be accessed by the control device 16, a control device functionality 50 which can be activated by the processor 46 in the control device 16. If the control device functionality 50 includes program code instructions, for example for logically combining individual inputs or outputs 18, 20 and/or internal states, activation of the control device functionality 50 indicates the execution, in particular a cyclical execution, of relevant program code instructions.

During activation, i.e., during execution of the program code instructions in the control device functionality 50, the cycle in the control device 16 is rigidly coupled to a corresponding control cycle in the drive controller 14, thereby eliminating beat-frequencies in the drive system 10. The coupling is illustrated in FIG. 2 by a double arrow 52 and may be implemented with coupling elements 52, for example a conventional Dual-Port Random Access Memory (DP-RAM), as symbolized by the double arrow 52.

To simplify handling of the drive system 10, the control device 16 already includes a standard Programmed Logic Controller (PLC) program as part of the control device functionality 50 upon delivery, so that the drive system 10 requires only a few operating steps to begin operation. The standard PLC program also enables a user of the drive system 10 to modify the drive system 10 and to adapt the operating characteristic of the drive system 10 to the user requirements. Since the disadvantageous prior-art limitation regarding the use of unrestricted modules has now been eliminated, the drive system 10 can now be adapted to practically any conceivable standard drive application. It is important that the drive system 10 still appears to the outside as a single drive system 10. The handling of alarms by the control device 16, which acts as an “Embedded PLC”, also remains unchanged.

In summary, the invention can be described as follows: a drive system 10 for a shaft is proposed, which includes a control device 16, a drive controller 14 and at least one input 18 for receiving input signals and at least one output 20 for supplying output signals. The drive controller 14 includes drive controller firmware 38 which stores linkable functional control elements 44. The control device 16 allows both logical combination of individual inputs and/or outputs 18, 20 and/or internal states and parameterization and/or configuration of the functional control elements 44. The drive controller 14 and the control device 16 in the drive system 10 are synchronized, with the drive controller 14 operating as a master.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by letters patent is set forth in the appended claims and includes equivalents of the elements recited therein:

1. A drive system for a shaft, comprising:
a control device comprising at least one input for receiving input signals and one output for outputting output signals, and
a drive controller comprising drive controller firmware which stores combinable regulating functional elements, with the drive controller and the control device being synchronized inside the drive system, with the drive controller operating as a master,
wherein the control device allows both logical combination of the at least one input or the at least one output or internal states and at least one of parameterization and configuration of the regulating functional elements.

2. The drive system of claim 1, wherein the control device and the drive controller each comprise a dedicated processor which activates a control device functionality.

3. The drive system of claim 1, wherein the control device and the drive controller each comprise drive controller firmware stored in a memory associated with the control device and a memory associated with the drive controller.

4. The drive system of claim 2, further comprising a common processor for the control device and the drive controller, wherein the processor activates the control device functionality.

5. The drive system of claim 3, further comprising a common processor for the control device and the drive controller, wherein the processor activates the drive controller firmware.

6. The drive system of claim 1, further comprising a coupling element operatively connecting the drive controller and the control device for synchronizing the drive controller with the control device.

7. The drive system of claim 6, wherein the drive controller and the connected control device are synchronized either by the drive controller or by the control device.

8. The drive system of claim 6, wherein the coupling element comprises a dual-port Random-Access-Memory (RAM).
